(19) United States
(12) Patent Application Publication
(10) Pub. No.: US 2011/0097501 A1
(43) Pub. Date: Apr. 28, 2011

(54) Methods for extracting titanium metal and useful alloys from titanium oxides

(75) Inventors: Michael J. Hollins, Newark, DE (US); Cameron R. May, Newark, DE (US); Viril Irick, JR., New Castle, DE (US)

(73) Assignee: Lanxide Technology Company, Newark, DE (US)

(21) Appl. No.: 10/593,899

(22) PCT Filed: Mar. 22, 2005
(86) PCT No.: PCT/US2005/009359

§ 371 Date: Jul. 24, 2007

Related U.S. Application Data
(60) Provisional application No. 60/555,217, filed on Mar. 22, 2004.

(51) Int. Cl. B05D 5/00; B05D 7/00; B22F 3/02; B22D 19/00; C22B 34/12

(52) U.S. Cl. 427/399; 427/214; 419/66; 164/91; 75/392

(57) ABSTRACT

Titanium-containing metal is extracted from its oxide(s) by way of a redox chemical reaction with a reducing metal. Specifically, an intimate mixture of the reducing metal and the titanium-containing oxide(s) is produced, in a preferred embodiment, by forming a metal-ceramic composite material featuring these two constituents. In a preferred embodiment, the composite body is made by infiltrating the reduced metal in molten form, into a permeable mass containing the titanium-bearing oxide(s). Concurrently or subsequent to infiltration, the redox reaction is carried out to transform the composite material, thereby forming a complex intimate mixture containing one or more oxides of the reducing metal, a titanium-containing metal, which could include an alloy of titanium with the reducing metal and/or one or more intermetallic compounds of titanium and the reducing metal, and possibly also some residual reducing metal, which itself possibly contains some titanium metal. One technique for removing the titanium-containing metal is to then comminute the transformed composite material while the metal constituent is still molten, such as by high speed shearing. The dispersed ceramic constituents can then be permitted to separate, and the metal component containing the titanium can simply be decanted.

### BACKGROUND OF THE INVENTION

1. Field of the Invention

The present invention relates to methods for extracting titanium metal from titanium-bearing ores. The invention furthermore relates to methods for making metal-ceramic composites, such as metal matrix composites containing various forms of titanium and aluminum metals, or their oxides.

2. Discussion of Related Art

Standard raw materials used in present day industrial methods of producing titanium (Ti) metal include rutile, anatase, leucoxene, perovskite, ilmenite, heavy-mineral sands and various intermediate/partially refined versions of these starting materials comprised of the element titanium combined with other metals such as iron and atomic oxygen to in the form of mixed oxides. While Titanium is the ninth most abundant element on the planet, it occurs in nature only in chemical combinations.

For example, rutile is 93-96% titanium dioxide; ilmenite contains 44-70% titanium dioxide; and leucoxene concentrates contain up to 90% titanium dioxide. The chemical formula for rutile—that is, titanium oxide—is TiO₂. For ilmenite, it is (Fe,Mg,Mn)TiO₃. Such oxides are notably thermodynamically stable, thus require aggressive thermochemical processes to break the mixed oxides down into individual chemical constituents.

Historically, the most commonly used process for extraction of Ti metal from mixed oxides is either the Hunter Process (sodium reduction) or the Kroll (magnesium reduction) Process. Briefly, the Kroll process, invented by William J. Kroll in 1940, is the first step in the production of sponge (so-called for it's sponge-like appearance) and involves the carbochlorination of titanium-containing rutile ore, usually derived from heavy mineral sand. Chlorine and coke are combined with the ore to produce titanium tetrachloride (TiCl4), which is then reacted with magnesium in a closed system. The by-products are sponge and magnesium chloride. Using processes such as the Timet Vacuum Distillation Process, or Kroll-leach process, the magnesium and magnesium chloride are removed to be recycled.

The sponge is melted with scrap and/or alloying elements such as vanadium, aluminum, molybdenum, tin and zirconium in a Vacuum Arc Reduction furnace (to produce VAR ingots) or in an Electron Beam (EB) Cold Hearth furnace, to produce remelt electrodes which can then be VAR melted (typically to meet aerospace requirements) or direct cast to slabs.

Another technique for extracting titanium from an oxide, particularly for use in alloying of ferrous metals, and one that has been practiced extensively by the Russians in particular, has been to pour molten aluminum onto or into a mass of ilmenite or ilmenite ore. A redox reaction ensues, forming as reaction products aluminum oxide and iron-titanium intermetallic compounds. Unfortunately, the titanium produced by this technique is always in the form of a compound, and never as elemental titanium. This is satisfactory and sufficient for the alloying of iron with minor amounts of titanium, but entirely unsatisfactory for the production of titanium-based metals.

A number of metallothermic, metallochemical and electrochemical reduction processes are being investigated for reducing various titanium containing compounds to titanium metal. See, for example, “Summary of Emerging Titanium Technologies”, published by EHK Technologies in November 2003 for the U.S. Department of Energy and Oak Ridge National Laboratory under Contract No. DE-ACO5-00OR22725, subcontract number 4000023694. Many of these techniques pertain to various electrochemical reduction techniques taking place in electrochemical cells. From a prior art standpoint, these techniques do not appear very relevant to the present invention.

Other techniques, such as metallothermic reduction, are more relevant. One such technique, called “Preform Reduction”, developed by Professor Okabe at the University of Tokyo involves suspending a preform of TiO2 and flux above a molten bath of calcium metal. Calcium metal vapor undergoes an oxidation/reduction chemical reaction (hereinafter referred to as a “redox” reaction with the TiO2 to produce Ti metal and CaO. These reaction products are then separated from one another by washing/leaching. The flux for this process is CaO or CaC12. Different Ti particle sizes and morphologies can be produced by varying the flux, the flux/TiO2 ratio and/or processing temperature, which is reported to be in the range of about 1073K-1273K. The process can be conducted in about 6 hours using a Ca/Ti ratio of about 0.5.

One well-known technique for making shaped metallic or metal-containing parts is that of die casting. Here, molten metal such as aluminum or alloys thereof, is injected under pressures on the order of thousands of pounds per square inch into a mold, typically made of a ferrous-based metal, and having a cavity inversely replicating the shape of the part to be molded. U.S. Pat. No. 5,429,175 to Thieman et al. and assigned to THT Presses, Inc., discloses an improved vertical die casting machine. Among the features of this apparatus is a means for evacuating the mold prior to injection, injecting the molten metal in a vertical direction, each of these practices tending to reduce porosity or voids in the molded part, and thus permitting lower injection pressures. Other features include conduits or through-passages for water-cooling of the mold to help solidify the die casting, and an insulated transfer tube to help keep the supply of metal “upstream” of the mold in a molten condition.

In the 1980's and 1990's, Lanxide Corporation of Newark, Del., pioneered two techniques for making metal-ceramic composite materials. Each technique featured the infiltration of a molten metal into a permeable mass of solid material that occurred spontaneously, that is, without the usual requirement for the application of pressure or vacuum to accomplish the infiltration.

The technique known as the PRIMEX pressureless infiltration process resulted in the production of a metal matrix composite body. In this process, in the presence of a wetting agent termed an “infiltration enhancer”, and in the presence of a non-oxidizing atmosphere, a molten metal called a “matrix metal” such as aluminum or an alloy of aluminum could spontaneously permeate a porous mass of solid, substantially inert material termed “filler material”. The infiltration enhancer could be provided to any one of the molten metal, the infiltration atmosphere, or the permeable mass, but typically was provided to the latter. A popular infiltration enhancer is magnesium nitride, and a popular method for providing it is to form it in-situ in the permeable mass by the reaction of magnesium metal in solid, liquid or vapor form with a source of vapor-phase nitrogen. Accordingly, nitrogen-containing atmospheres such as elemental nitrogen, forming gas or ammonia are preferred infiltrating atmospheres. Also preferred is to alloy the magnesium in the matrix metal, or to admix it with the permeable mass in solid form, in each instance at concentrations generally in the range of about 0.5 percent to about 10 percent by weight.

Lanxide's other technique for making metal-ceramic composites was termed the DIMOX directed metal oxidation process, and it produced ceramic matrix composites. Here, the molten metal is termed a “parent metal”, and like the PRIMEX process for making MMC's, the parent metal infiltrates the permeable mass of substantially inert filler material to form the composite. Further, wetting agents called dopants may be required to achieve the required wetting condition. Unlike the PRIMEX process, here the DIMOX process involves oxidizing the parent metal to form a ceramic material that becomes the matrix (or part of the matrix) of the composite. The rates of wetting and oxidation are in balance or equilibrium with each other so that as parent metal wets and infiltrates in to the permeable mass, it is continually oxidized at the front or interface between the metal and oxidant, but that the molten parent metal is able to continue to wick through its own developing oxide layer.

More specifically, with the correct combination of atmosphere, parent metal alloy chemistry and temperature, the molten parent metal can be caused to oxidize such that it does not form a passivating layer but rather forms a non-passivating oxide layer at the interface between the oxidant and the source of molten metal. Molten metal continues to be transported through the developing surface oxide layer, not by a diffusion process, but by way of microscopic channels in the developing oxide layer. The oxidant typically is in the form of a vapor-phase oxidant such as gaseous oxygen, but could also be in condensed form, such as an oxide glass or a solid oxidant, such as an oxide reducible by the molten parent metal. This directed metal oxidation phenomenon can be caused to occur into a permeable mass of filler material, either inert or made inert, to the chemical environment, to form a ceramic composite reinforced with the filler material. In one embodiment of this process, the oxidant is supplied in the form of a condensed matter oxidant provided in the permeable mass.

The oxidant is typically a vapor-phase oxidant, but Lanxide taught that the oxidant could be in either vapor, liquid or even solid phase. Furthermore, the oxidant does not have to be an oxygen-containing substance. Rather, oxidation is given its broader chemical meaning referring to the transfer of electrons between the oxidant and the reductant reactants. A common example of the vapor-phase embodiment is directing the oxidation of molten aluminum alloy through a silicon carbide perform in the presence of air to form a ceramic matrix composite featuring the silicon carbide reinforcing a matrix of aluminum oxide (oxygen being a stronger oxidant than the nitrogen component of air). Some residual, interconnected aluminum alloy is also present in the composite and distributed throughout the matrix. A typical example of the solid oxidant embodiment is the directed oxidation of a molten zirconium parent metal into a permeable mass containing boron carbide as the oxidant to form a ceramic composite featuring a matrix of zirconium boride and zirconium carbide. Again, some residual unreacted and generally interconnected parent metal is distributed throughout the matrix of the composite.

The LANXIDE directed metal oxidation process taught that unexpected reactions can occur when molten aluminum parent metal is placed in intimate contact with oxygen-containing solid oxidant compounds (hereinafter known as Solid Phase Reactants) such as silicon dioxide. Specifically, the molten Parent Metal reacts with the Solid Phase Reactant, reducing the latter and simultaneously creating an oxide of the molten Parent Metal. The reaction releases the metal constituent of the Solid Phase Reactant into the molten Parent Metal to either alloy with it, or to remain as a second phase, as dictated by the solubility of the metals in each other at the operating temperature of the process.

In the example using molten Aluminum (Parent Metal) and solid silicon dioxide (Solid Phase Reactant), the resulting reaction products are aluminum oxide, Al—Si alloy and unalloyed Si metal. Upon cooling, the constituents remain in these forms, with the percentages dictated by miscibility relationships as a function of temperature.

It should be noted that experimental work by Lanxide Corporation, and others, have shown that it is not yet known how to make accurate thermodynamic predictions of whether certain directed metal reduction reactions will chemically proceed, because of the intertwined complexity of unknown kinetic relationships governing reactions such as those involving molten Parent Metal and Solid Phase Reactants.

The problems with existing techniques for extracting and refining titanium are well known. In particular, the processes used rely on chemical substances that are dangerous to health, safety and the environment, and must be used with the utmost caution. Further, the process that is the commercial standard, the Kroll Process, is quite expensive relative to those for refining iron or aluminum. Moreover, the processes that involve the redox reaction of a molten metal lack the kind of intimate contact of a wetting condition between the liquid and solid phases, which hinders the reaction process. The present invention addresses these and other issues.

### OBJECTS OF THE INVENTION

It is an object of the present invention to chemically reduce titanium metal from titanium-bearing ores more economically and efficiently than existing techniques.

It is an object of the present invention to chemically reduce titanium metal from titanium-bearing ores in a more environmentally benign way than existing techniques.

It is an object of the present invention to produce commercial popular grades of titanium alloys, such as Ti-6Al-4V, with fewer process steps than are currently required.

It is an object of the present invention to produce titanium-containing intermetallic compounds.

It is an object of the present invention to produce a metal-ceramic composite material containing titanium, either in oxidized or reduced form.

It is an object of the present invention to produce a metal-ceramic composite material containing, as reinforcement, an oxide of titanium.

It is an object of the present invention to produce a metal-ceramic composite material containing, preferably in interconnected form, and possibly as a matrix component of the composite, titanium metal or a titanium-containing metal.

### SUMMARY OF THE INVENTION

It appears that prior attempts at reducing titanium metal from its oxide by using another metal to perform an oxidation-reduction (“redox”) reaction have suffered from a lack of intimate contact and/or lack of a wetting condition between the titanium-containing oxide and the reducing metal. Accordingly, the present invention addresses and solves this problem by making a metal and ceramic composite material from these two constituents, specifically, a metal matrix composite that exhibits the intimate contact, and preferably one that features a wetting condition whereby molten reducing metal can wet the titanium-containing oxide(s). Thus, this composite material is sometimes interchangeably referred to as “the intimate mixture” or “intimate admixture”. A chemical reaction, in particular a redox reaction, occurs or is caused to occur between these two constituents, whereby at least some of the reducing metal becomes oxidized by the titanium-containing oxide(s), and conversely the latter is chemically reduced, preferably in their entirety, by the reducing metal. Preferably, the chemical reduction proceeds completely to metallic titanium, rather than to a suboxide of TiO2, of which titanium is known to have more than one. In one embodiment, this chemical reaction occurs concurrently with the infiltration process. In this embodiment, the titanium-containing oxides function in a role similar to that of the Solid Phase Reactant in the Lanxide directed metal oxidation (DIMOX™) process.

In another embodiment, the redox reaction occurs subsequent to infiltration, and possibly requiring further heating, such as a heat treatment, to make the reaction occur. Such heat treatment will consist of selected time-temperature-atmosphere furnace operating profiles as to promote the oxidation of the reducing metal, resulting in a solid or gaseous form of the reducing metal oxide and the liberation of molten titanium metal from the titanium-containing oxide(s).

The resulting product of the redox reaction consists of a mixture of one or more oxides of the reducing metal, a titanium-containing metal, which could include an alloy of titanium with the reducing metal and/or one or more intermetallic compounds of titanium and the reducing metal, and possibly also some residual reducing metal, which itself possibly contains some titanium metal, e.g., as an alloying constituent. At this point, the titanium in reduced form, i.e., the titanium-containing metal(s) can be removed or separated from the oxide by a number of known industrial techniques.

### DEFINITIONS

“Reducing Metal”, as used herein, means the material used to fulfill the chemical requirement of reducing agent in the description of this invention. It is also referred to, from time to time, as the “infiltrant” or “infiltrant metal” in this invention.

### DETAILED DESCRIPTION OF THE INVENTION AND PREFERRED EMBODIMENTS

According to the methods of the present invention, an intimate mixture of a reducing metal and one or more titanium-containing oxides is accomplished by preparing a metal-ceramic composite material of these constituents. Simultaneous or subsequent to the formation of the composite material, a redox reaction is initiated, thereby oxidizing the reducing metal and reducing the titanium-containing oxide(s), preferably all the way to a metallic state (e.g., metallic titanium). In other words, the redox reaction results in oxygen being stripped from the titanium oxide-bearing minerals, forming aluminum oxide, and simultaneously releasing reduced species such as titanium metal into the system.

An important aspect of the present invention is the creation of conditions of intimate contact between the reducing metal and oxidized species (e.g., aluminum and titania). Intimate contact, enhancing an oxidation-reduction reaction, can be obtained via placing a loose bed of titanium dioxide particles in close contact with a block/ingot of aluminum alloy. Chemical dopants can be applied at the interface between the loose titanium dioxide particle bed and the aluminum alloy ingot to enhance complete wetting of the titanium dioxide particle surfaces in the bed by the molten aluminum alloy. Additionally, press compacting alternating layers of aluminum alloy sheets and layers of titanium dioxide can enhance intimate contact. Alternately, molten aluminum, under protective vacuum or inert cover gas, can be introduced to the titanium dioxide particle bed by pouring it from a melting vessel onto the preheated bed of particles.

During the process of creating the intimate admixture, molten reducing metal migrates or “infiltrates” into the titanium-containing oxide particle bed by mass or bulk flow. In this way a metal-ceramic composite body is produced. If an oxidizing atmosphere is present, there may be some or substantial oxidation of reducing metal with the atmosphere. The reducing metal becomes the matrix of the composite body, or part of the matrix, as it migrates into the bed of oxide particles. Typically, upon completion of the infiltration process, there is no pore space left, and the original pore space in the bed of oxide particles is now occupied by matrix material. Provided that there has been little or no chemical reaction between the metal and the oxide particles during this infiltration step, the composite material that is the intimate admixture at this stage consists of the oxide particles distributed through the matrix, which can be reducing metal, or reducing metal together with some oxide of the reducing metal. The titanium-containing oxide particles can be substantially or essentially completely surrounded by matrix material.

In a preferred embodiment, the intimate mixture includes titanium oxide-bearing ores (such as anatase, rutile and/or titanium bearing sands comprising mixtures of titanium oxide and “impurity” oxides such as forms of iron oxide) and aluminum or aluminum alloy. The present inventors teach a number of techniques for making the intimate admixture. For example, pressure casting or squeeze casting techniques commonly used in the aluminum casting industry can be employed to obtain an intimate mixture of titanium oxide bearing ore particles and molten aluminum alloy. Cooling of the mixture, either at atmospheric pressure or at elevated pressure “freezes” this intimate mixture of reactants. In the absence of dopants or wetting agents such as infiltration enhancer agents (or appreciable amounts of ilmenite, which in any event is not conducive to producing free titanium metal), molten aluminum alloy poured under ambient pressure conditions onto a bed of titanium oxide bearing ore particles will not inherently wet and infiltrate the bed of particles, but will remain as a “puddle” on the ore. Accordingly, under these conditions, it probably will be necessary to force the molten metal into a rigidized or otherwise constrained bed of particles under an externally applied pressure, or an internally applied or generated vacuum. Thus, the pressure or vacuum that is applied can beneficially affect the kinetics of infiltration of the titanium oxide bearing ore particles by molten aluminum alloys.

Therefore, in a first preferred embodiment aimed at producing an intimate mixture of aluminum alloy and titanium dioxide bearing ore particles, pressure can be applied by a press designed to inject molten aluminum alloy into a mold cavity, such as equipment manufactured by THT Presses, Inc. of Dayton, Ohio. Experimentation by the present inventors has shown that such equipment effectively injects molten aluminum alloy into a mold cavity loosely filled with titanium dioxide bearing ore particles, thereby decreasing the fabrication time for forming intimate reactant combinations and minimizing the need to preshape the reactants.

In a second preferred embodiment, to produce an intimate mixture of aluminum alloy and titanium oxide bearing ore one may utilize the “spontaneous infiltration” or PRIMEX pressureless infiltration process taught in the patents granted to Lanxide Technology Company L.P. to effect an intimate mixture of aluminum alloy and titanium dioxide bearing ores. For example, in the aluminum/magnesium/nitrogen system, it was discovered that an aluminum alloy containing at least 1 wt % of magnesium could create a wetting condition and infiltrate a permeable mass of ceramic filler material in an atmosphere containing at least about 10 vol % nitrogen-containing gas, the balance being a non-oxidizing gas. This infiltration could occur without the assistance of pressure or vacuum, whether externally applied (as in squeeze casting) or internally created, as in the so-called “self-generated vacuum process”, another metal infiltration technology pioneered by Lanxide Technology Company L.P. In the pressureless infiltration process, the temperature could be slightly above the melting point of the aluminum alloy, but more typically was in the range of about 700 C to about 800 C.

As the PRIMEX™ pressureless infiltration process technology was better understood, it was discovered that an important aspect of the process was the temporary formation of an intermediate reaction product, termed the “infiltration enhancer” at a temperature below that of molten aluminum but above that of molten magnesium. For example, in the aluminum/magnesium/nitrogen infiltration system, it was discovered that magnesium metal contained in the permeable mass or present in the reaction chamber was chemically reacting with the nitrogen-containing gas at a temperature less than that of molten aluminum to form magnesium nitride infiltration enhancer. At least some of this magnesium nitride took the form of a solid coating on the bodies of ceramic filler making up the permeable mass to be infiltrated. As the temperature of reaction is raised above the melting point of molten aluminum, the molten aluminum had a high affinity toward wetting this magnesium nitride coating. Simultaneously, the molten aluminum metal chemically reacted with the magnesium nitride in an oxidation-reduction reaction to form aluminum nitride plus magnesium metal, which typically alloyed with the molten aluminum and was available for further reaction in the nitrogen atmosphere. Subsequent metallographic analysis showed aluminum nitride adhered to at least some portion of the ceramic filler material surface. Thus, this understanding showed that the magnesium component, which was termed the “infiltration enhancer precursor”, did not have to be alloyed with the aluminum matrix metal necessarily, but could be supplied within the permeable mass and/or from the atmosphere, e.g., by means of the generation of a partial pressure of magnesium metal in the chamber. It furthermore showed that the process could be performed in stages that could be separated in time and/or place. In particular, one could first supply infiltration enhancer material such as magnesium nitride to the permeable mass by reacting a partial pressure of magnesium with a nitrogen gas atmosphere at a temperature less than the melting point of aluminum, or form it in-situ such as by a vapor coating process such as chemical vapor deposition. Later, at the time and place of one's choosing, the pressureless infiltration process can be performed with molten matrix metal such as a suitable molten aluminum alloy. Thus, a permeable mass of the titanium-oxide bearing ore is sufficiently coated on the particle surfaces with an infiltration enhancer such as magnesium nitride. In other words, by preheating an admixture of Solid Phase Reactant particles and magnesium metal powder in a nitrogen atmosphere, one can form a thin layer of magnesium nitride on said particles. The admixture is now in a condition to be spontaneously infiltrated by molten matrix metal such as aluminum.

In a third embodiment of the invention, aimed at producing an intimate mixture of aluminum alloy and titanium dioxide bearing ore a permeable mass of the titanium-oxide bearing ore is sufficiently coated on the particle surfaces with an infiltration enhancer according to the second embodiment such that the mixture may now be infiltrated with molten aluminum alloy by means of the first embodiment, e.g., a pressure assist similar to squeeze casting.

In a fourth embodiment of the invention, one can use the previously mentioned DIMOX directed metal oxidation process to produce the intimate admixture. Here, the admixture also contains a ceramic oxide of the parent metal (e.g., aluminum oxide), and therefore could also be considered to be a ceramic matrix composite. Specifically, a permeable mass containing the titanium-bearing oxide(s) can be brought into contact with a molten parent metal containing aluminum, possibly in an oxidizing atmosphere such as air, but preferably in an inert or reducing atmosphere. If the goal or end-use is the production of a ceramic composite body, then the permeable mass may also contain one or more substantially inert (or rendered inert) filler materials to influence the properties of the composite body. However, if the objective is the production of titanium metal from its oxide, then there may be little use for such filler materials. The aluminum parent metal may need to be “doped” with one or more chemical dopant materials such as silicon, magnesium and/or zinc to create favorable wetting conditions, and the processing temperature is generally within the range of about 800 C to about 1600 C. Some dopants such as sodium can have an effect even in concentrations as low as several parts per million, but more typically the dopant concentrations are on the order of one-half to several percent. Under these conditions, the molten aluminum parent metal will wet the permeable mass and will infiltrate the mass. Concurrently, aluminum will undergo an oxidation-reduction reaction with the titanium-containing oxide(s), reducing them to titanium metal, with itself being oxidized to aluminum oxide. The amount of aluminum parent metal supplied should be in excess of what is required stoichiometrically to react all of the titanium-bearing oxide present. It is possible, perhaps even likely, that some or perhaps even all of the reduced titanium metal will react with aluminum metal to form one or more intermetallic compounds. Thus, the resulting metal-ceramic composite, like the metal matrix composite described above, will be a complex mixture of aluminum oxide, aluminum metal or alloy, possibly titanium metal or alloy, and/or one or more titanium-aluminum intermetallic compounds.

In a similar manner, as described above for aluminum, magnesium and calcium are anticipated to be effective reducing metals for this invention.

Once the intimate admixture has been formed, a redox chemical reaction is then carried out to chemically reduce the oxide(s) of titanium, and concurrently oxidize some or all of the reducing metal within the intimate admixture. In some of the preferred embodiments for making the intimate admixture, particularly the DIMOX directed metal oxidation process, the redox reaction may have occurred simultaneously with the infiltration process. To the extent that it has not yet occurred, it is then time to bring this redox reaction about. Accordingly, the intimate mixture of reducing metal and titanium-containing oxides produced in the first three embodiments can be further processed by heat treating the intimate mixture, generally at a temperature in excess of the infiltration temperature, and preferably in an inert atmosphere or vacuum, to cause the reduction of the titanium oxide-bearing ore by the reducing metal. When the reducing metal is or contains aluminum as its most reactive component, the reaction products formed as a result of this redox reaction contain titanium metal and aluminum oxide. Since it is generally desirable to reduce all of the titanium-containing oxides, the reducing metal typically is provided in excess, and therefore some excess unoxidized aluminum metal may be present in the final heat treated body. If the further processing is carried out at a temperature in excess of about 1850 C, the reduced titanium metal will be in a molten condition, which could assist the redox process. Due to alloying and some by-product or side reactions, the actual chemical composition and microstructure that actually, results from the heat treatment may be somewhat more complicated than described immediately above. For example, titanium and aluminum metals can chemically react with one another to form a number of intermetallic compounds, generally denoted as TixAly, and referred to as titanium aluminides. Additionally, titanium and aluminum will dissolve in each other, up to the solubility limits of the two metals, given selected process operating temperatures. Thus, the composite body or intimate admixture following the heat treatment process could feature the following phases in its microstructure: titanium, titanium alloy, aluminum, aluminum alloy, various titanium aluminides, and aluminum oxide. These constituents can be separated via processes less chemically onerous than those of the Kroll or Hunter Processes. Environmental concerns are mediated by the proposed invention via eliminating extremely hazardous tetrachloride compounds. The aluminum oxide produced by this invention is expected to be of rather high purity and usable as ceramic raw material.

Thus, the material that is produced as a result of the redox reaction is a complicated intertwined three-dimensional structure. Such a heterogeneous material structure might be a desirable ceramic particle reinforced metal matrix composite (hereinafter known as MMC). MMC's containing these constituents are anticipated to demonstrate advantageous properties including high fracture toughness, chemical resistance and attractive tribological properties. Depending upon the amount of aluminum oxide present, and particularly if there was oxidation of aluminum from a vapor-phase oxidant such as air, the aluminum oxide phase may also be interconnected, thereby contributing a ceramic phase to the matrix of the composite material.

At this point, the titanium in reduced form, i.e., the titanium-containing metal(s) can be removed or separated from the oxide by a number of known industrial techniques. For example, one can cool the mixture, solidifying the metal components to yield a solid metal-ceramic composite body, and comminuting the body to increase the surface area available for a subsequent chemical or metallurgical extraction process. Alternatively, and mindful that the ceramic phase(s) in the mixture are not strongly bonded to one another, one may take the mixture while the metal component is still molten and break up these weak ceramic bonds, for example by stirring using an impeller, or by crushing with a rod or anvil. Then, in the absence of stirring, the loose ceramic particles will tend to separate out of the melt such that in a crucible containing the mixture, the molten metal can be decanted.

Furthermore, it is predicted that various alpha, alpha-beta and beta stabilized titanium alloys can be made with this process. It is anticipated that appropriate amounts of selected alpha and beta stabilizers—such as vanadium—can be uniformly added, as the oxide, or metal, form of the stabilizer, resulting in a body with correct homogenous alloy chemistry for various stabilized titanium alloys. Specifically, it is anticipated that vanadium can be added to the parent metal in metal form and/or can be added to the bed containing the titanium oxide(s) in either metallic or oxide form.

The invention will now be further described with reference to the following non-limiting examples.

### Example I

This Example demonstrates, among other features, the use of a pressure casting process to produce intimately bonded metal matrix composites of anatase and-aluminum.

500 grams of anatase powder (CPM Grade 4010, 40-100 mesh, CPM Industries, Wilmington, Del.) was placed in an aluminum foil container measuring approximately 100 mm diameter by 25 mm thick. The foil container was protected by an aluminum mesh overwrap made from window screen material. The overwrapped sample was placed in an air furnace and the furnace raised to a temperature of 560° C. and held for one hour. The furnace door was opened and the overwrapped sample of anatase and magnesium was removed from the furnace and quickly transferred to the cavity of a vertical aluminum casting machine (THT Industries, Dayton Ohio). Molten aluminum casting alloy (356 alloy) was rapidly injected into the cavity containing the anatase. After a short dwell the cavity was opened and the solidified metal matrix composite mixture of aluminum and anatase removed.

Radiographic analysis of the metal matrix composite showed no observable porosity and a uniform distribution of anatase and aluminum. Metallographic analysis showed good bonding between the aluminum and the anatase and a uniform distribution of anatase in the aluminum matrix.

### Example II

This Example demonstrates, among other features, the magnesium nitride coating of titanium dioxide powders.

About 2 weight percent of magnesium powder (Hart Metals 100-200 grit) was thoroughly mixed with anatase powder (CPM Grade 4010, 40-100 mesh) in a metal container. About 500 grams of the mixture was contained in an aluminum foil container measuring approximately 100 mm diameter by 25 mm thick. An aluminum mesh overwrap made from window screen material protected the foil container. The overwrapped sample was placed in a sealed muffle of a controlled atmosphere furnace. The muffle was evacuated to about 20 KPa pressure using a mechanical vacuum pump. The muffle was backfilled with nitrogen gas and the evacuation was repeated. After a second backfill with nitrogen gas to raise the pressure in the muffle to atmospheric pressure and with a flow rate of nitrogen of approximately 3 l/min the furnace was raised to a temperature of 560° C. and held for one hour. The muffle door was opened and the overwrapped sample of anatase and magnesium was removed from the muffle. The magnesium powder contained in the mix had reacted with the flowing nitrogen gas to form a coating of magnesium nitride on the surface of the anatase particles.

### Example III

This Example demonstrates, among other features, a magnesium nitride coating and PRIMEX™ pressureless infiltration to form intimately bonded metal matrix composites of anatase and-aluminum.

A 30 cm×30 cm×10 cm deep alumina refractory boat containing 90 grit NYAD wollastonite powder (NYCO Minerals, Inc., Willsboro, N.Y.) was used as an experiment container. Two aluminum foil containers, each 8 cm×12 cm×8 cm deep, contained a 2.5 cm deep layer of anatase powder (CPM Grade 4010, 40-100 mesh) and a 8 cm×12 cm×2.5 cm thick billet of Al-2Mg alloy. The foil containers holding the anatase and alloy were buried in the 90 grit NYAD wollastonite powder to a depth such that only their upper surface was exposed. One foil container had the anatase powder on the bottom—under the billet, and one had the powder on top of the billet. The boat and its contents was heated to about 1250° C., in air, for about 50 hours and then furnace cooled.

Chemical analysis indicated the presence of titanium metal in the resulting composite.

### Example IV

This Example demonstrates, among other significant features, a nitridation-assisted pressure casting to form intimately bonded metal matrix composites of anatase and aluminum.

The experiment carried out in Example II above was repeated for the purpose of applying a magnesium nitride coating to the anatase particles. Upon removal of the magnesium nitride coated anatase from the muffle it was quickly transferred to the cavity of a vertical aluminum pressure casting machine (THT Industries, Dayton Ohio). The magnesium nitride coating rendered the bed of anatase particles self-supporting. Molten aluminum casting alloy (Aluminum Association 356 alloy) was rapidly injected into the cavity containing the nitrided anatase. After a short dwell the cavity was opened and the solidified composite mixture of aluminum and anatase removed. Radiographic analysis of the metal matrix composite showed no observable porosity and a uniform distribution of anatase and aluminum. Metallographic analysis showed good bonding between the aluminum and the anatase and a uniform distribution of anatase in the aluminum matrix.

### Example V

This Example demonstrates, among other significant features, the nitridation and pressure casting processes, followed by heat treatment at 1250° C.

Samples of anatase/aluminum MMC produced according to Example N above were heated in a vacuum provided by a mechanical roughing pump to about 1250° C., held for about 5 hours, and furnace cooled. X-Ray Diffraction and image analysis confirm the presence of aluminum oxide and titanium metal. Chemical analysis indicated the presence of titanium metal in increasing quantities towards the bottom of the resulting sample.

### INDUSTRIAL APPLICABILITY

In addition to providing a new technique for extracting titanium-containing metal(s) from their ores (e.g., their oxides), the present invention describes techniques for making titanium-containing metal-ceramic composite materials. For example, a titania reinforced aluminum composite material could find utility in applications needing yield strength higher than what most aluminum alloys can provide, but where common aluminum-based MMC's such as Al/SiC would be too abrasive.

The term “ore” permeates this disclosure. This term suggests a raw, unrefined admixture of minerals as dug out of the earth. While it may be possible to use the unrefined titanium-containing ores in the permeable mass to be infiltrated according to the present invention, more likely, the ore will be refined, e.g., beneficiated in one or more ways before it is subjected to the infiltration and reduction processes.

An artisan of ordinary skill will readily appreciate that numerous modifications can be made to the invention that is described above without deviating or departing from the scope of the invention as defined in the following claims.

1. A method for producing a magnesium nitride coating on the particles in a loose bed of at least one titanium containing oxide to improve the wetting of the oxide by molten aluminum alloy, the method comprising providing a nitrogen-containing atmosphere to said particles, and contacting a source of magnesium metal in a molten or vapor phase to said loose bed.

2. A method for producing a metal matrix composite body comprising at least one titanium containing oxide reinforcement in an aluminum alloy matrix by means of a pressure casting process, the method comprising:
a. providing a powder bed comprising at least one titanium-containing oxide;
b. providing at least one alloy of aluminum as an infiltrant;
c. pressure infiltrating said infiltrant into said powder bed to form a composite body; and
d. cooling such composite body to form a solid.

3. A method for producing a metal matrix composite comprising at least one titanium containing oxide reinforcement in an aluminum alloy matrix by using a pressure-less infiltration process
a. providing a permeable mass comprising at least one titanium-containing oxide the particles of which have been coated with magnesium nitride;
b. providing at least one aluminum-based metal as an infiltrant;
c. in molten form, at atmospheric pressure infiltrating said infiltrant into said permeable mass to form a composite body; and
d. cooling such composite body to form a solid.

4. A method for producing a metal matrix composite body comprising at least one titanium-containing oxide reinforcement in an aluminum alloy matrix by means of a wetting enhancer and a pressure casting process
a. providing a permeable mass comprising particulate of at least one titanium-containing oxide, the particles of which have been coated with magnesium nitride;
b. providing at least one alloy of aluminum as an infiltrant;
c. pressure infiltrating said infiltrant into said permeable mass to form a composite body; and
d. cooling such composite body to form a solid.

5. A method for reducing titanium metal from its oxides, comprising:
a. providing a composite body by means of claim 1; and
b. chemically reacting said reducing aluminum of said matrix and said titanium-containing oxide in said composite body in a redox reaction to form a chemically transformed composite body, and thereby reducing said titanium-containing oxide to a titanium-containing metal.

6. A method for reducing titanium metal from its oxides, comprising:
a. providing a permeable mass comprising at least one titanium-containing oxide;
b. providing at least one alloy of aluminum as an reactive infiltrant; and
c. reactively infiltrating said alloy into said titanium containing oxide to form a composite comprising aluminum oxide, and titanium-containing metal.

7. The method of claim 6, wherein said infiltrating is done in an oxidizing atmosphere to produce a ceramic matrix composite, and further wherein said ceramic matrix composite comprises at least one titanium-containing oxide.

8. A method for reducing titanium metal from its oxides comprising:
a. Forming a ceramic matrix composite pursuant to claim 6; and
b. Further chemically reacting said constituents of said ceramic matrix composite redox reaction to form a chemically transformed composite body and thereby reducing said titanium-containing oxide to a titanium-containing metal.

9. The method of claim 6, wherein said ceramic matrix composite further comprises at least one of elemental titanium and at least one aluminide of titanium.

10. The method of claim 5, further comprising separating said titanium-containing metal from said chemically transformed composite body.

11. The method of claim 6, further comprising separating said titanium-containing metal from said composite body.

12. The method of claim 3, wherein said infiltrating is carried out at a temperature of at least about 700 C.

13. The method of claim 6, wherein said reactive infiltration is carried out at a temperature of at least about 1250 C.

14. The method of claim 5, wherein said redox reaction is carried out at a temperature of at least about 1250 C.

15. The method of claim 5, wherein said redox reaction is carried out at a temperature of at least about 1850 C.

16. The method of claim 5, further comprising adding at least one alpha titanium stabilizer to at least one of the reducing metal and the bed (or permeable mass).

17. The method of claim 5, further comprising adding at least one beta titanium stabilizer to at least one of the reducing metal and the bed (or permeable mass).

18. The method of claim 5, further comprising adding vanadium metal to at least one of the reducing metal and the bed (or permeable mass).

19. The method of claim 5, further comprising adding at least one oxide of vanadium to the bed (or permeable mass).

20. The method of claim 10, wherein said titanium-containing metal comprises titanium stabilized in at least one form selected from the group consisting of alpha, beta, and alpha-beta forms.

21. A method for reducing titanium metal from its oxides, comprising:
a. providing a composite body by means of claim 2; and
b. chemically reacting said reducing aluminum of said matrix and said titanium-containing oxide in said composite body in a redox reaction to form a chemically transformed composite body, and thereby reducing said titanium-containing oxide to a titanium-containing metal.

22. A method for reducing titanium metal from its oxides, comprising:
a. providing a composite body by means of claim 3; and
b. chemically reacting said reducing aluminum of said matrix and said titanium-containing oxide in said composite body in a redox reaction to form a chemically transformed composite body, and thereby reducing said titanium-containing oxide to a titanium-containing metal.

23. The method of claim 8, further comprising separating said titanium-containing metal from said chemically transformed composite body.

24. The method of claim 7, further comprising separating said titanium-containing metal from said composite body.

25. The method of claim 8, wherein said redox reaction is carried out at a temperature of at least about 1250 C.

26. The method of claim 8, wherein said redox reaction is carried out at a temperature of at least about 1850 C.

27. The method of claim 11, wherein said titanium-containing metal comprises titanium stabilized in at least one form selected from the group consisting of alpha, beta, and alpha-beta forms.
